(19) United States
(12) Patent Application Publication
(10) Pub. No.: US 2026/0288342 A1
(43) Pub. Date: Sep. 24, 2026

(54) SYSTEM AND METHOD FOR IDENTIFYING AND MANAGING RELATED STORAGE VOLUMES IN A BACKUP ENVIRONMENT

(71) Applicant: Eon IO, Ltd., Tel Aviv (IL)

(72) Inventors: Rachel NERIYA SCHIFTER, Herzliya (IL); Yair WEISS, Givatayim (IL); Ron KIMCHI, Tel Aviv (IL); Dmitry KUZNETSOV, Tel Aviv Yafo (IL); Assaf NATANZON, Tel Aviv (IL)

(73) Assignee: Eon IO, Ltd., Tel Aviv (IL)

(21) Appl. No.: 19/087,950

(22) Filed: Mar. 24, 2025

(51) Int. Cl. G06F 3/06

(52) U.S. Cl. CPC G06F 3/0614; G06F 3/0644; G06F 3/0673

(57) ABSTRACT

A system and method for identifying and managing related storage volumes is provided. The method includes scanning a plurality of cloud computing environments to identify a plurality of storage volumes; obtaining volume data for each of the plurality of storage volumes, wherein the volume data includes a plurality of metadata identifiers; analyzing the plurality of metadata identifiers to determine one or more lineage identifiers indicating a common lineage among the plurality of storage volumes; determining associations among the plurality of storage volumes based on a comparison of the one or more lineage identifiers; and generating and outputting one or more data structures based on the determined associations, wherein the one or more data structures represent the common lineage among the plurality of storage volumes.

### TECHNICAL FIELD

The present disclosure relates generally to digital backup in computing environments, and more particularly to techniques for identifying, tracking, and managing storage volumes that share a common origin or lineage across multiple computing environments.

### BACKGROUND

In many computing environments, storage volumes are frequently created, replicated, and moved across multiple virtual machines, cloud accounts, and regions. Over time, the relationship among these volumes can become difficult to ascertain, particularly when file system or partition identifiers remain unchanged or only partially updated. As a result, multiple copies of substantially the same data may be unknowingly retained, thereby increasing storage costs and introducing potential security concerns.

Additionally, some volumes become “orphaned” following machine deletions, snapshot operations, or migrations. Such unattached volumes often remain unnoticed, further contributing to storage costs and posing compliance risks. Conventional backup and cloud management tools typically provide limited visibility into volume metadata, making it challenging to determine whether volumes share a common lineage or whether they remain actively in use.

Consequently, many computing environments lack a comprehensive view of their stored data, hindering the ability to identify relationships among volumes or to determine which volumes are no longer necessary. This limited visibility impedes effective storage planning and leads to inefficiencies across diverse environments and platforms.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include scanning a plurality of cloud computing environments to identify a plurality of storage volumes. The method may also include obtaining volume data for each of the plurality of storage volumes, where the volume data includes a plurality of metadata identifiers. The method may furthermore include analyzing the plurality of metadata identifiers to determine one or more of the lineage identifiers indicating a common lineage among the plurality of storage volumes. The method may in addition include determining associations among the plurality of storage volumes based on a comparison of the one or more lineage identifiers. The method may moreover include generating and outputting one or more data structures based on the determined associations, where the one or more data structures represent the common lineage among the plurality of storage volumes. Other embodiments of this aspect include corresponding computer systems, apparatus, and computer programs recorded on one or more computer storage devices, each configured to perform the actions of the methods.

Implementations may include one or more of the following features. The method where scanning the plurality of computing environments is performed via one or more calls to application programming interfaces (APIs) or agent-based services associated with at least one virtualization platform. The method where obtaining the volume data further may include: retrieving partition information from at least one of a Master Boot Record (MBR) or a GUID Partition Table (GPT). The method where analyzing the plurality of metadata identifiers further may include: normalizing each of the metadata identifiers to enable comparisons across differing file system types. The method may include: storing the plurality of metadata identifiers in a repository accessible by a backup system, where entries in the repository map each storage volume to the corresponding metadata identifiers. The method where generating and outputting the one or more data structures further may include: creating a connectivity graph, where nodes represent the plurality of storage volumes and edges represent relationships among the storage volumes based on the one or more lineage identifiers. The method may include: initiating a deduplication process to merge storage volumes determined to be duplicates based on matching lineage identifiers. The method may include: detecting, among the plurality of storage volumes, at least one volume that is unattached to a computing environment and classifying the at least one volume as a dangling volume for subsequent remediation. The method where obtaining the volume data further may include: retrieving Logical Volume Manager (LVM) identifiers including at least one of a volume group (VG) identifier or a logical volume (LV) identifier. The method where the plurality of cloud computing environments includes at least two distinct public cloud services, each providing a separate interface for scanning and obtaining the volume data. The method where analyzing the plurality of metadata identifiers further may include: comparing volume labels, timestamps, or other secondary attributes to confirm a common lineage when the one or more lineage identifiers have been partially changed. The method where analyzing the plurality of metadata identifiers further may include: applying heuristic logic to assign a similarity score to pairs of storage volumes. The method where the one or more lineage identifiers include at least one of a filesystem-level Universally Unique Identifier (UUID), a partition-level Globally Unique Identifier (GUID), or a New Technology File System (NTFS) volume serial number. The method where analyzing the plurality of metadata identifiers further may include: comparing one or more secondary attributes to confirm a common lineage when the one or more lineage identifiers have been partially changed. The method may include: generating a user interface, where the user interface displays at least one connectivity graph linking stored volumes determined to share the one or more lineage identifiers. Implementations of the described techniques may include hardware, a method or process, or a computer tangible medium.

In one general aspect, a non-transitory computer-readable medium may include one or more instructions that, when executed by one or more processors of a device, cause the device to: scan a plurality of cloud computing environments to identify a plurality of storage volumes; obtain volume data for each of the plurality of storage volumes, where the volume data includes a plurality of metadata identifiers; analyze the plurality of metadata identifiers to determine one or more of lineage identifiers indicating a common lineage among the plurality of storage volumes; determine associations among the plurality of storage volumes based on a comparison of the one or more lineage identifiers; and generate and output one or more data structures based on the determined associations, where the one or more data structures represent the common lineage among the plurality of storage volumes. Other embodiments of this aspect include corresponding computer systems, apparatus, and computer programs recorded on one or more computer storage devices, each configured to perform the actions of the methods.

In one general aspect, a system may include one or more processors configured to: scan a plurality of cloud computing environments to identify a plurality of storage volumes; obtain volume data for each of the plurality of storage volumes, where the volume data includes a plurality of metadata identifiers; analyze the plurality of metadata identifiers to determine one or more of lineage identifiers indicating a common lineage among the plurality of storage volumes; determine associations among the plurality of storage volumes based on a comparison of the one or more lineage identifiers; generate and outputting one or more data structures based on the determined associations, where the one or more data structures represent the common lineage among the plurality of storage volumes. Other embodiments of this aspect include corresponding computer systems, apparatus, and computer programs recorded on one or more computer storage devices, each configured to perform the actions of the methods.

Embodiments of the present disclosure may be provided as a network of communicating devices (i.e. a “computerized network”). Embodiments of the invention may be also provided as a software application downloadable into a computer device to facilitate the method. The software application may be a computer program product, which may be stored on a non-transitory computer-readable medium on a tangible data-storage device (such as a storage device of a server, or one within a user device).

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

In the drawings:

FIG. 1 is an example network diagram illustrating a backup system for identifying and managing related storage volumes, in accordance with an embodiment of the present disclosure.

FIG. 2 is an example flowchart illustrating a high-level process for scanning computing environments, obtaining volume data, and analyzing metadata, in accordance with an embodiment of the present disclosure.

FIG. 3 is an example flowchart illustrating a process for identifying volume types and extracting metadata identifiers, in accordance with an embodiment of the present disclosure.

FIG. 4 is an example flowchart illustrating a process for comparing metadata across volumes and grouping matching metadata identifiers, in accordance with an embodiment of the present disclosure.

FIG. 5 is an example schematic diagram illustrating a connectivity graph that includes multiple volumes, a snapshot, and an orphaned volume, in accordance with an embodiment of the present disclosure.

FIG. 6 is an example flowchart illustrating a process for detecting unattached volumes and providing remediation options, in accordance with an embodiment of the present disclosure.

FIG. 7 is an example schematic diagram of a backup system, according to an embodiment of the present disclosure.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

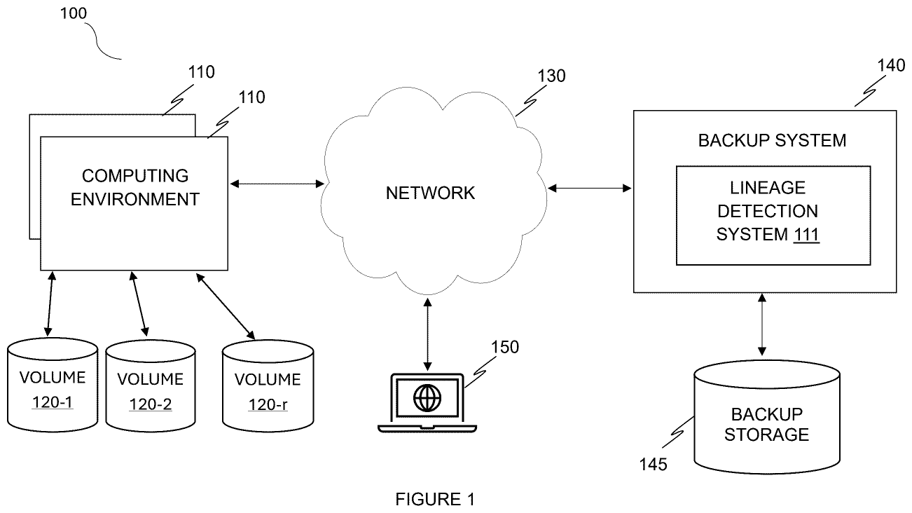

FIG. 1 is an example network diagram 100 illustrating a backup system for identifying and managing related storage volumes, in accordance with an embodiment of the present disclosure. In embodiments, a computing environment 110 is configured to execute one or more workloads (e.g., virtual machines, containers), each having associated volumes 120-1, 120-2, . . . , 120-r. These volumes may be implemented as block-level devices, partitions, or file-based storage in public clouds, private data centers, or hybrid deployments.

In some embodiments, the computing environment 110 can represent on-premises infrastructure, public cloud platforms (e.g., Amazon® Elastic Compute Cloud, Microsoft® Azure), containerized orchestration frameworks (e.g., Kubernetes®, Docker®), or a hybrid deployment. Multiple such environments may exist, each running on different platforms or providers. Scanning these computing environments for volumes enables the detection of common lineage, as volumes 120-1, 120-2, . . . , 120-r may originate from diverse sources or snapshot operations.

In some embodiments, each volume 120 can be a logical or physical block storage device attached to or hosted by the computing environment 110. Volumes may hold data in various file system formats, such as New Technology File System (NTFS), Fourth Extended File System (ext4), X File System (XFS), or partition schemes, such as Master Boot Record (MBR), and Globally Unique Identifier Partition Table (GPT). During backup or snapshot activities, volumes may be duplicated or moved to different environments, and over time, multiple volumes may share an origin or lineage. Detecting these relationships enables the identification of redundant or orphaned volumes for better cost and security management.

In some embodiments, a network 130 provides connectivity between the computing environment(s) 110 and the backup system 140. The network 130 may include local area networks (LANs), wide area networks (WANs), or public cloud networks such as the Internet. Scanning and metadata retrieval processes can involve API calls or agent-based communications transmitted over the network 130. The network 130 may also facilitate user interactions from remote devices or consoles that manage or configure backup settings.

In some embodiments, a backup system 140 orchestrates the process of identifying and managing related volumes. The backup system 140 may operate on dedicated hardware or in a cloud-based service, communicating with the computing environment(s) 110 through network 130. The backup system 140 can initiate scans, collect volume metadata, and store results needed to assess lineage, as well as provide interfaces for deduplication, orphaned volume detection, and other tasks aimed at optimizing storage resources and enforcing security or compliance policies.

In some embodiments, a lineage detection system 111 may be provided within (or in communication with) the backup system 140. The lineage detection system 111 is responsible for analyzing the metadata collected from volumes 120, comparing file system IDs (e.g., UUIDs, volume serial numbers, GUIDs), and ultimately determining whether multiple volumes share a common lineage. The lineage detection system 111 may also store and index these identifiers, generating data structures or graphs that depict how volumes relate. This functionality enables automated discovery of duplicate, derivative, or orphaned volumes across various computing environments.

In some embodiments, backup storage 145 maintains volume snapshots, backups, or other preserved data to facilitate fault tolerance or archival objectives. In some embodiments, the backup system 140 uses backup storage 145 to store images of the volumes 120 or incremental backup data.

A user device 150, such as a laptop, desktop, or mobile device running a management console, may connect to the backup system 140 via the network 130. The user device 150 may allow administrators or other users to configure scanning schedules, view lineage reports, initiate deduplication tasks, and address orphaned volumes. The user device 150 may be used for interactive management and oversight, providing visibility into volume relationships across the computing environments 110. In some embodiments, users can also decide to delete orphaned volumes once they understand their origin, thereby saving storage space.

In an embodiment, by scanning volumes and leveraging multi-layered backup practices that evaluate filesystem identifiers (e.g., ext4 UUID, XFS UUID, MBR/GPT partition signatures, the backup system 140 can detect volumes sharing a common lineage. In some embodiments, the system may also analyze resource tags allowed by many cloud providers. Such detection reduces storage overhead, enhances security by locating orphaned volumes containing sensitive information, and enables notification or cleanup actions where appropriate.

Although FIG. 1 illustrates two computing environments 110, a network 130, a backup system 140, and a user device 150, it is understood that additional environments, networks, or devices may be present in other embodiments. For example, the backup system 140 may integrate with external storage or specialized data management modules, provided they help identify and manage the lineage of volumes.

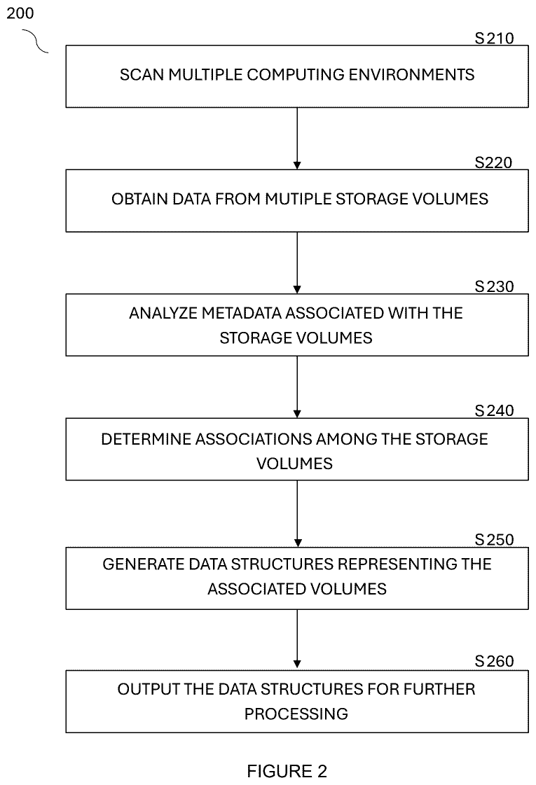

FIG. 2 is an example flowchart 200 illustrating a high-level process for scanning computing environments, obtaining volume data, and analyzing metadata, in accordance with an embodiment of the present disclosure.

At S210, multiple computing environments are scanned. For example, a discovery process may be performed to locate available storage volumes across various virtualization platforms, cloud accounts, or on-premises servers. In some embodiments, a lineage detection system may initiate queries through interfaces such as cloud provider APIs or agent-based probes. For example, calls can be made to list volumes in an Amazon Web Services region, a Microsoft® Azure® account, or a VMware environment. In some multi-cloud or cross-region cases, volumes or snapshots may traverse different providers (e.g., Amazon® Web Services, Azure®) or geographic locations. As part of the scanning and lineage detection process, the metadata from these varied environments may be normalized, ensuring that a volume's lineage is recognized even if it was migrated or replicated between distinct cloud regions, across multiple clouds, or from on-premises to a cloud environment. In an embodiment, the scanning may occur periodically (e.g., weekly) or in response to a user request through a management console. By creating an inventory of volumes, relevant resources can be analyzed for potential lineage in subsequent steps.

At S220, volume data is obtained. Following the identification of volumes across multiple computing environments, the lineage detection system may request and retrieve metadata for each volume. The retrieved metadata may include the filesystem type (e.g., ext4, NTFS, or XFS), partition layout (e.g., MBR, GPT), or other descriptive parameters (e.g., volume labels, timestamps). In some embodiments, agents installed in the respective computing environments may communicate directly with the lineage detection system, providing a range of metadata identifiers, such as labels or timestamps. The retrieved data may be stored in a repository accessible by a backup system, ensuring that enough data is available to detect relationships among volumes. In some embodiments, obtaining the volume data includes retrieving cloud-level resource tags or metadata tags applied at the provider level (e.g., AWS tags, Azure resource tags). These tags may contain user-assigned or automatically generated identifiers that, along with filesystem or partition-level identifiers, aid in determining a volume's lineage.

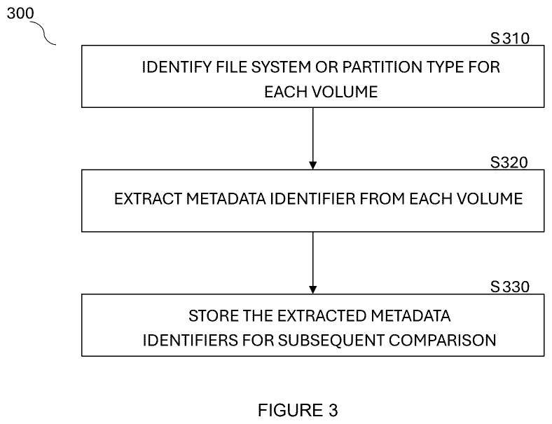

At S230, the obtained metadata is analyzed. In some embodiments, the lineage detection system may analyze the collected metadata to identify one or more lineage identifiers, which serve to indicate whether multiple volumes derive from a common origin. For example, lineage identifiers may include filesystem UUIDs, partition GUIDs, or NTFS Volume Serial Numbers. FIG. 3 provides a more detailed flowchart illustrating potential sub-steps in extracting and normalizing these identifiers. In some implementations, the broader set of metadata identifiers (e.g., timestamps, volume labels) may also be examined if a primary lineage identifier has been modified, missing, or partially re-randomized.

The collected metadata may be normalized (e.g., converting UUID strings to a consistent format) so that potential matches between volumes can be recognized despite variations in how the data is stored or reported. By distinguishing lineage identifiers from other metadata, the lineage detection system can more accurately determine volumes that are likely to come from a common source, ensuring that multiple identifiers are compared even when slight formatting or labeling discrepancies exist.

At S240, associations among the storage volumes are determined. In some embodiments, the lineage detection system primarily compares lineage identifiers (e.g., UUIDs, partition GUIDs, volume serial numbers) across all scanned volumes to identify matches or near-matches that suggest a common lineage.

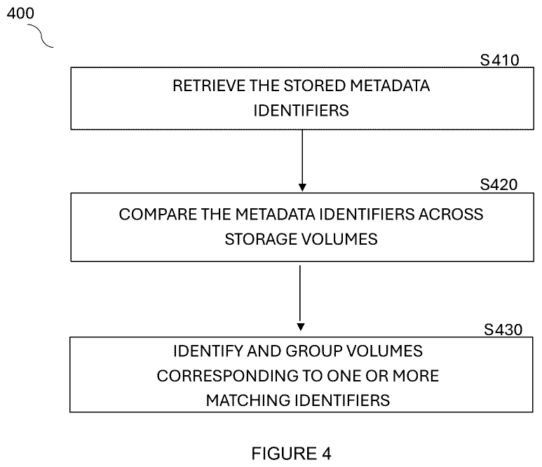

FIG. 4 provides a more detailed flowchart illustrating the comparison of identifiers and the grouping of related volumes. In example embodiments, when two or more volumes share identical lineage identifiers, the volumes are classified as associated. In cases where some lineage identifiers have been partially modified or randomized, heuristic checks (e.g., comparing secondary attributes such as timestamps or volume labels) may be employed to infer a high likelihood of common lineage.

In some embodiments, automated tools may intentionally randomize a filesystem's UUID or partition signature for compliance or uniqueness requirements. As a result, subsequent scans might detect near-identical volumes with only minor variations in their primary identifiers. In such cases, the system evaluates additional metadata to confirm whether the volumes share the same origin. The output of this step may be used to identify redundant data or orphaned volumes that pose security or compliance risks.

At S250, the results of the association analysis are consolidated. Once volumes with potential relationships have been identified, these relationships may be compiled into one or more data structures to facilitate efficient access and interpretation. For example, a connectivity graph may be generated, where nodes represent volumes and edges denote detected lineage or duplication. Alternatively, an indexed table can be employed to map each volume to any others sharing certain identifiers. These consolidated data structures may be maintained in a database within a backup system, enabling systematic tracking of related volumes. Additionally, any discovered orphaned volumes may be highlighted or flagged, providing insight into potential storage inefficiencies or security gaps.

At S260, the consolidated data structures are made available for further processing. For example, a user interface may be provided for visualizing or managing the identified relationships between volumes. In some embodiments, deduplication tasks may be invoked automatically, reducing storage costs by merging volumes deemed substantially identical. Security and compliance tools may also utilize the consolidated data to locate and remediate orphaned volumes in diverse computing environments. By systematically presenting lineage relationships, the backup system improves operational visibility, optimizes resource usage, and supports consistent data governance.

FIG. 3 is an example flowchart 300 illustrating a process for identifying volume types and extracting metadata identifiers, in accordance with an embodiment of the present disclosure. In some embodiments, the steps of FIG. 3 represent more detailed sub-steps of the metadata analysis introduced at S230 in FIG. 2.

At S310, the file system or partition type is identified for each volume. For example, a lineage detection system, integrated with or accessible by a backup system, may evaluate each discovered volume to determine its underlying format. This may involve reading partition information (e.g., MBR or GPT tables) or issuing system-level commands. In some embodiments, system-level commands such as blkid in Linux environments or relevant Windows APIs may be invoked to confirm whether a file system is NTFS, ext4, XFS, or another format.

In some embodiments, additional details, such as whether the partition is bootable or if a Logical Volume Manager (LVM) structure is present, may also be collected. In some implementations, if a volume is managed under an LVM, additional identifiers such as volume group (VG) or logical volume (LV) UUIDs may be extracted to enhance lineage detection. These identifiers can help the system link multiple logical volumes that originated from the same physical or snapshot source. Identifying the file system or partition type at an early stage helps tailor subsequent steps to the specific attributes of each volume.

At S320, a plurality of metadata identifiers is extracted from each volume. Once the file system or partition layout has been determined, the lineage detection system may retrieve these metadata identifiers, among which specific lineage identifiers (e.g., a UUID or a partition GUID) indicate whether multiple volumes share a common lineage. For example, in a Linux® environment, an ext4 file system may provide a UUID, while an XFS file system might include a different unique signature. In a Windows context, an NTFS Volume Serial Number might be read, and in a GPT-partitioned disk, a partition GUID may be identified. In addition to these lineage identifiers, the lineage detection system (111, FIG. 1) may also collect other metadata identifiers (e.g., timestamps, labels, or tags) that can help corroborate lineage if the primary lineage identifiers are missing or partially changed. The extracted identifiers are then stored in a consistent format for subsequent comparison (see FIG. 4 for an example).

At S330, the extracted metadata identifiers are stored for subsequent comparison. After retrieving the relevant identifiers, the lineage detection system may save them to a data repository or database accessible by the backup system. This repository may store entries linking each volume ID (or other reference) to its extracted metadata, thereby creating a unified record across all scanned computing environments. In some implementations, these entries may be normalized or indexed to speed up subsequent matching operations, such as converting UUID strings to a canonical representation or assigning internal identifiers for efficient lookups.

FIG. 4 is an example flowchart 400 illustrating a process for comparing metadata across volumes and grouping matching metadata identifiers, in accordance with an embodiment of the present disclosure. In some embodiments, the steps shown in FIG. 4 correspond to more detailed sub-steps of the association-determining process introduced at S240 in FIG. 2.

At S410, the stored metadata identifiers are retrieved. After metadata identifiers have been extracted (e.g., as described in FIG. 3) and stored in a central repository, the lineage detection system may access these records to perform cross-volume comparisons. For example, the repository may be a database or index accessible by the backup system, providing entries that map each volume to any UUIDs, partition GUIDs, or serial numbers that were captured. In some implementations, an internal module or service within the lineage detection system may issue queries to this repository, retrieving the relevant identifiers for all volumes under consideration.

At S420, the metadata identifiers are compared across the plurality of storage volumes. Among these identifiers, certain lineage identifiers (e.g., filesystem UUIDs or partition GUIDs) may be primarily used to determine a common lineage. For example, two volumes may possess the same ext4 UUID or NTFS Volume Serial Number, thereby indicating a strong likelihood of duplication or lineage from the same snapshot. In some embodiments, additional attributes (e.g., filesystem labels or creation timestamps) may serve as fallback or supporting evidence if a primary lineage identifier has been altered or partially regenerated. The identifier comparison may include an equality check (e.g., string matching) or involve heuristic logic that accounts for slight inconsistencies or partial matches. By examining all volumes in the repository, relationships that span multiple computing environments or involve different backup processes can be detected.

At S430, volumes corresponding to one or more matching identifiers are identified and grouped. Volumes that share identical or nearly identical metadata identifiers are flagged as related, indicating a common lineage or duplication event. In some embodiments, data structures (e.g., lists or graphs) may be created, marking each volume's connections to others with matching identifiers. These groupings can then be stored back in the repository or provided with a higher-level management layer for additional processing. For example, the backup system may merge or consolidate data associated with matching volumes, and an administrative interface may label certain volumes as “potential duplicates” or “orphaned” based on these relationships. In cases where only partial matches are detected, volumes may be assigned a probabilistic score reflecting their likelihood of sharing an origin, and policy-based logic can subsequently unify or quarantine volumes whose score exceeds a threshold.

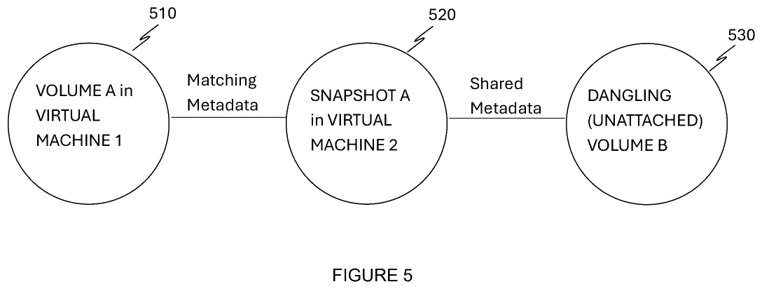

FIG. 5 is an example schematic diagram illustrating a connectivity graph that includes multiple volumes, a snapshot, and an orphaned volume, in accordance with an embodiment of the present disclosure. As shown in FIG. 5, Volume A 510 resides in a first virtual machine, Snapshot A 520 resides in a second virtual machine, and Volume B 530 is a dangling or unattached volume. Lines labeled “Matching Metadata” and “Shared Metadata” indicate that Volume A, Snapshot A, and Volume B share one or more identifiers (e.g. filesystem UUIDs, partition GUIDs, or volume serial numbers) suggesting they originate from the same lineage.

In some embodiments, a lineage detection system (e.g., within a backup system) may retrieve details about each volume by initiating discovery operations across different computing environments or cloud regions. For example, when Volume A 510 is located in the first virtual machine, the lineage detection system can issue queries or run agent-based checks to extract partition layouts and filesystem metadata (e.g., a Linux UUID or a Windows NTFS serial number). Once Snapshot A 520 is identified in the second virtual machine, the lineage detection system obtains corresponding metadata identifiers, storing them in a centralized repository (e.g., a database) for direct comparison. Over time, Volume B 530 may become detached from any running virtual machine due to a user-initiated operation, an automated snapshot restore, or migration activities. Upon rescanning the computing environment, the lineage detection system detects that Volume B's identifiers partially or fully match those of Snapshot A. This match may be determined through direct equality checks of UUID strings or heuristic comparisons of secondary attributes, such as volume labels and timestamps. This process reveals that the orphaned volume originated from the same source, even if some primary identifiers were changed during prior restore or cloning events.

By assembling these relationships into a connectivity graph, FIG. 5 shows how volumes spread across different virtual machines or in different states of attachment can be linked by shared identifiers or metadata. In some embodiments, once such lineage associations are discovered, the lineage detection system may highlight redundant volumes to be deduplicated or orphaned volumes that pose security risks or consume unnecessary storage. Users or automated workflows can then decide whether to merge data, reattach volumes to active workloads, or remove volumes entirely.

In certain embodiments, the backup system 140 (or an associated management console) provides a user interface. For example, a user may “right-click” on a displayed volume in the connectivity graph to view all known snapshots, clones, or related volumes sharing the same lineage, even if they reside in distinct regions or accounts. This feature enables users to quickly locate and remediate redundant volumes or verify the security posture of volumes believed to be “orphaned” in remote environments.

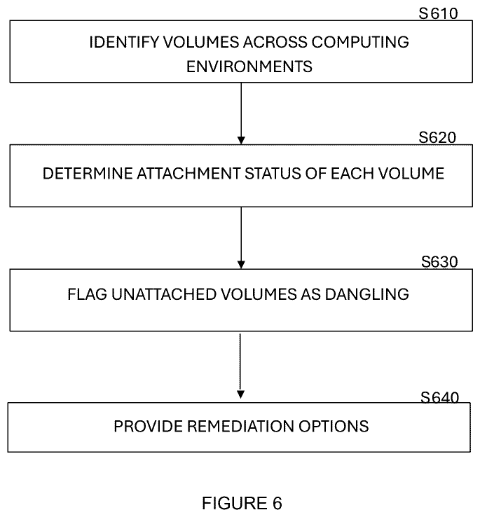

FIG. 6 is an example flowchart illustrating a process for detecting unattached volumes and providing remediation options, in accordance with an embodiment of the present disclosure. In some implementations, this process may be part of a broader volume management or backup system that identifies orphaned resources to optimize storage usage and address potential security concerns.

At S610, volumes are identified across computing environments. In one embodiment, a scanning procedure is performed by a backup or lineage detection system, which queries cloud APIs or on-premises infrastructure to discover volumes residing in different virtual machines, accounts, or regions. For example, the scanning procedure may include collecting basic metadata (e.g., volume IDs, labels, and partition formats) to establish a comprehensive record of all known storage volumes.

At S620, the attachment status of each volume is determined. After identifying volumes in S610, each volume may be evaluated to determine whether it is actively attached to a running machine or is otherwise in use. For example, an API call to a cloud provider may return the unique identifier of the instance (or virtual machine) to which a given volume is attached. If no such instance is reported, or if a volume's metadata indicates no current association with a host, the volume is classified as unattached.

At S630, any unattached volumes are flagged as “dangling.” Based on the attachment status, each volume determined as having no active host connection may be marked accordingly. Labeling volumes in this manner enables users or automated routines to quickly distinguish resources that might require further action.

At S640, remedial options are provided. Once the system identifies dangling volumes, an interface or automated policy engine may offer various remedial actions. For example, such actions can include deleting the unattached volumes to reclaim storage capacity, reattaching them to existing virtual machines, or archiving them for compliance purposes. In some implementations, alerts or recommendations may be generated regarding volumes deemed potentially redundant or high-risk, enabling optimization of resource usage and minimization of security or compliance concerns.

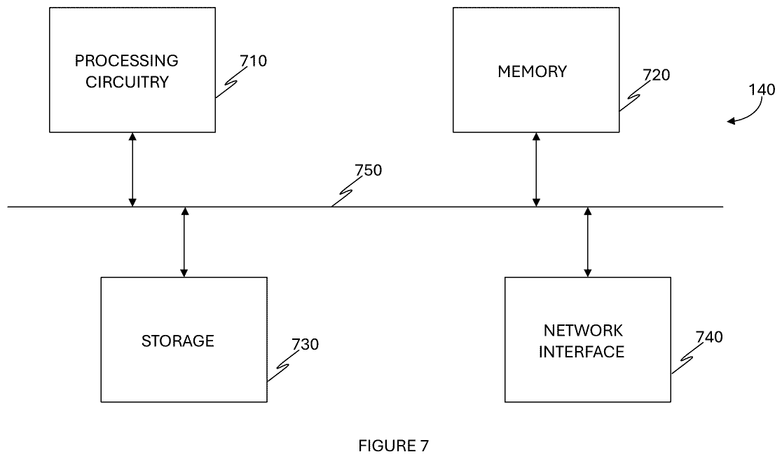

FIG. 7 is an example schematic diagram of a backup system 140 according to an embodiment. The backup system 140 includes, according to an embodiment, processing circuitry 710 coupled to a memory 720, a storage 730, and a network interface 740. In an embodiment, the components of the backup system 140 are communicatively connected via a bus 750.

In certain embodiments, the processing circuitry 710 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information. In some embodiments, the processing circuitry 710 executes instructions related to discovering storage volumes, analyzing metadata (e.g., filesystem UUIDs, partition GUIDs), identifying volume lineage, and providing backup management capabilities as disclosed herein.

In an embodiment, the memory 720 is a volatile memory (e.g., random access memory), a non-volatile memory (e.g., flash memory), or a combination thereof. In some embodiments, the memory 720 is an on-chip memory, an off-chip memory, or any combination thereof. The memory 720 may store data structures (e.g., volume metadata tables, lineage graphs) or program instructions enabling the backup system 140 to scan multiple computing environments, perform lineage detection, and carry out other processes described in this disclosure.

In one configuration, software for implementing one or more embodiments disclosed herein is stored in the storage 730, in the memory 720, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). When executed by the processing circuitry 710, these instructions cause the backup system 140 to perform various processes described herein, such as retrieving volume data, comparing metadata identifiers, identifying orphaned volumes, and providing deduplication or remediation options.

In some embodiments, the storage 730 is a magnetic storage, an optical storage, a solid-state storage, or a combination thereof, realized, for example, as a flash memory or a hard disk drive. The storage 730 may hold backup files, snapshots, metadata identifying shared or duplicate volumes, and other relevant information needed for volume lineage detection and resource optimization. By maintaining such data, the backup system 140 can correlate multiple volumes across different environments and highlight their lineage relationships or orphaned status.

The network interface 740 is configured to provide the backup system 140 with communication to, for example, a cloud provider, one or more computing environments (such as virtual machines or containers), or other external services. In some embodiments, the network interface 740 enables the system to initiate scans of storage volumes, retrieve or update metadata, and communicate with administrative consoles or policy engines responsible for evaluating redundant or orphaned volumes.

It should be understood that the embodiments described herein are not limited to the specific architecture illustrated in FIG. 7, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for identifying and managing related storage volumes, the method comprising:
scanning a plurality of cloud computing environments to identify a plurality of storage volumes;
obtaining volume data for each of the plurality of storage volumes, wherein the volume data includes a plurality of metadata identifiers;
analyzing the plurality of metadata identifiers to determine one or more lineage identifiers indicating a common lineage among the plurality of storage volumes;
determining associations among the plurality of storage volumes based on a comparison of the one or more lineage identifiers; and
generating and outputting one or more data structures based on the determined associations, wherein the one or more data structures represent the common lineage among the plurality of storage volumes.

2. The method of claim 1, wherein scanning the plurality of computing environments is performed via one or more calls to application programming interfaces (APIs) or agent-based services associated with at least one virtualization platform.

3. The method of claim 1, wherein obtaining the volume data further comprises: retrieving partition information from at least one of a Master Boot Record (MBR) or a GUID Partition Table (GPT).

4. The method of claim 1, wherein analyzing the plurality of metadata identifiers further comprises: normalizing each of the metadata identifiers to enable consistent comparisons across differing file system types.

5. The method of claim 1, further comprising: storing the plurality of metadata identifiers in a repository accessible by a backup system, wherein entries in the repository map each storage volume to the corresponding metadata identifiers.

6. The method of claim 1, wherein generating and outputting the one or more data structures further comprises: creating a connectivity graph, wherein nodes represent the plurality of storage volumes and edges represent relationships among the storage volumes based on the one or more lineage identifiers.

7. The method of claim 1, further comprising: initiating a deduplication process to merge storage volumes determined to be duplicates based on matching lineage identifiers.

8. The method of claim 1, further comprising: detecting, among the plurality of storage volumes, at least one volume that is unattached to a computing environment and classifying the at least one volume as a dangling volume for subsequent remediation.

9. The method of claim 1, wherein obtaining the volume data further comprises: retrieving Logical Volume Manager (LVM) identifiers including at least one of a volume group (VG) identifier or a logical volume (LV) identifier.

10. The method of claim 1, wherein the plurality of cloud computing environments includes at least two distinct public cloud services, each providing a separate interface for scanning and obtaining the volume data.

11. The method of claim 1, wherein analyzing the plurality of metadata identifiers further comprises: comparing volume labels, timestamps, or other secondary attributes to confirm a common lineage when the one or more lineage identifiers have been partially changed.

12. The method of claim 1, wherein analyzing the plurality of metadata identifiers further comprises: applying heuristic logic to assign a similarity score to pairs of storage volumes.

13. The method of claim 1, wherein the one or more lineage identifiers include at least one of a filesystem-level Universally Unique Identifier (UUID), a partition-level Globally Unique Identifier (GUID), or a New Technology File System (NTFS) volume serial number.

14. The method of claim 1, wherein analyzing the plurality of metadata identifiers further comprises: comparing one or more secondary attributes to confirm a common lineage when the one or more lineage identifiers have been partially changed.

15. The method of claim 1, further comprising: generating a user interface, wherein the user interface displays at least one connectivity graph linking stored volumes determined to share the one or more lineage identifiers.

16. A non-transitory computer-readable medium storing a set of instructions for identifying and managing related storage volumes, the set of instructions comprising:
one or more instructions that, when executed by one or more processors of a device, cause the device to:
scan a plurality of cloud computing environments to identify a plurality of storage volumes;
obtain volume data for each of the plurality of storage volumes, wherein the volume data includes a plurality of metadata identifiers;
analyze the plurality of metadata identifiers to determine one or more lineage identifiers indicating a common lineage among the plurality of storage volumes;
determine associations among the plurality of storage volumes based on a comparison of the one or more lineage identifiers; and
generate and outputting one or more data structures based on the determined associations, wherein the one or more data structures represent the common lineage among the plurality of storage volumes.

17. A system for identifying and managing related storage volumes comprising:
one or more processors configured to:
scan a plurality of cloud computing environments to identify a plurality of storage volumes;
obtain volume data for each of the plurality of storage volumes, wherein the volume data includes a plurality of metadata identifiers;
analyze the plurality of metadata identifiers to determine one or more lineage identifiers indicating a common lineage among the plurality of storage volumes;
determine associations among the plurality of storage volumes based on a comparison of the one or more lineage identifiers; and
generate and outputting one or more data structures based on the determined associations, wherein the one or more data structures represent the common lineage among the plurality of storage volumes.
